(19) United States
(12) Patent Application Publication
(10) Pub. No.: US 2024/0274001 A1
(43) Pub. Date: Aug. 15, 2024

(54) METHOD FOR PROCESSING ACCIDENT INFORMATION AND VEHICLE OPERATION CONTROL SERVER USING THE SAME

(71) Applicants: Hyundai Motor Company, Seoul (KR); Kia Corporation, Seoul (KR)

(72) Inventor: Minwoo Lee, Anyang-Si (KR)

(21) Appl. No.: 18/384,245

(22) Filed: Oct. 26, 2023

(30) Foreign Application Priority Data
Feb. 15, 2023 (KR) 10-2023-0019964

(51) Int. Cl. G08G 1/01; G08G 1/09

(52) U.S. Cl. CPC G08G 1/0137; G08G 1/0112; G08G 1/09

(57) ABSTRACT

A vehicle operation control server includes a communication device transmitting and receiving information to and from a vehicle through a network, an accident information collecting processor collecting detailed record data on an accident acquired by an event data recorder of an accident vehicle related to the accident through the communication device, and an accident information processing processor determining accident response measures for a subsequent vehicle that follows the accident vehicle based on the collected accident information.

### CROSS-REFERENCE TO RELATED APPLICATION

This application claims priority to and the benefit of Korean Patent Application No. 10-2023-0019964 filed in the Korean Intellectual Property Office on Feb. 15, 2023, the entire contents of which are incorporated herein by reference.

### BACKGROUND

When a traffic accident occurs on a road in which vehicles drive, such as a highway or a general road, a driver of the vehicle or a passer-by passing the location in which the traffic accident occurs may manually report the traffic accident in many cases.

The driver of the vehicle may install behind the accident vehicle a tripod on the road to inform a driver of a vehicle that approaches the accident vehicle of the occurrence of the accident, thereby preventing the occurrence of a secondary accident.

If a traffic accident occurs in a place where people are sparse, such as a highway, or if there are no vehicles passing by, there may be limitations in reporting the traffic accident by a user who is in the traffic accident, and therefore, vehicles that are to pass by the scene of the traffic accident may inevitably pass by the scene of the traffic accident without receiving information related to the occurrence of the traffic accident in advance, and a secondary accident may frequently occur because the vehicle of the traffic accident in front is not recognized.

As such, there is a problem in that a driver of a vehicle to pass by the scene of the traffic accident may suffer discomfort of being delayed for a long time at the scene of the traffic accident.

### SUMMARY

The following summary presents a simplified summary of certain features. The summary is not an extensive overview and is not intended to identify key or critical elements.

An object of the present invention is to provide a method for collecting and processing accident information and a vehicle operation control server using the same.

An apparatus may comprise: a communication device configured to communicate with at least one vehicle; and at least one processor configured to: receive, from the at least one vehicle, record data of an accident, wherein the record data is acquired by an event data recorder of the at least one vehicle related to the accident; and determine, based on the record data, an accident response instruction for a vehicle that follows an accident vehicle.

The at least one vehicle may comprise the accident vehicle. The at least one processor may be configured to: receive location information of the accident vehicle, and determine, based on the location information of the accident vehicle, an accident location in which the accident occurs.

The at least one processor may be configured to: transmit, to the at least one vehicle, a request for accident information via the communication device, and receive, based on the request for accident information, the record data.

The at least one processor may be configured to: transmit, to the at least one vehicle, a request for accident information via the communication device, and receive, based on the request for accident information, image data associated with at least one image of the accident acquired by a video recording device of the at least one vehicle.

The at least one processor may be configured to, based on a determination that accident-related information on the accident needs to be additionally collected through the communication device, transmit a request for the record data and the image data.

The at least one processor may be configured to, based on a determination that accident-related information on the accident needs to be additionally collected through the communication device, transmit, to the at least one vehicle, a request for image data within a certain time range associated with an accident time at which the accident occurs, wherein the at least one vehicle comprises a nearby vehicle located in the accident location, and receive, based on the request for image data, image data acquired by a video recording device of the nearby vehicle.

The nearby vehicle may be a vehicle that transmits event data recorder (EDR) data including data associated with EDR data provided from the accident vehicle within the certain time range.

The nearby vehicle may be a vehicle that transmits event data recorder (EDR) data including specific data associated with the accident within the certain time range.

The at least one processor may be configured to: determine, based on the record data, an accident severity value indicating severity of the accident, determine, based on the determined accident severity value, the accident response instruction, and transmit the accident response instruction via the communication device.

The at least one processor may be configured to: determine the accident severity value based on: a quantity of accident vehicles involved in the accident, a quantity of accident vehicles in which at least one airbag is deployed, and a quantity of vehicles of which deceleration rates are greater than or equal to a deceleration threshold.

The at least one processor may be configured to, based on the accident severity value being greater than or equal to a certain critical value, transmit, to the vehicle that follows the accident vehicle, accident section information indicating an accident location and accident image data for the accident via the communication device.

The at least one processor may be configured to, based on the accident severity value being greater than or equal to the certain critical value, search for a detour route that bypasses the accident location, and transmit, to the vehicle that follows the accident vehicle, the detour route via the communication device.

The at least one processor, based on the accident severity value being less than a certain critical value, may transmit accident section information indicating an accident location and an accident occurrence notification, to the vehicle that follows the accident vehicle, via the communication device.

The communication device may receive a portion of the record data from an audio video navigation telematics (AVNT) device of the accident vehicle.

A method performed by a computing device may comprise: receiving an accident occurrence signal from a first accident vehicle; determining a first accident section in which an accident of the first accident vehicle occurs; receiving an accident occurrence signal from a second accident vehicle; determining a second accident section in which an accident of the second accident vehicle occurs; transmitting, to the first accident vehicle and the second accident vehicle, a request for accident information; receiving accident record acquired by an accident recording device of at least one of the first accident vehicle or the second accident vehicle; and transmitting, based on the accident record, an accident response instruction for at least one vehicle that follows at least one of the first accident vehicle or the second accident vehicle.

The method may further comprise receiving, based on the request for accident information, accident image data acquired by a video recording device of at least one of the first accident vehicle or the second accident vehicle.

The method may further comprise: based on the first accident section and the second accident section being the same and based on an accident time at which the accident of the first accident vehicle occurs and an accident time at which the accident of the second accident vehicle occurs being within a certain time period, determining that the accident of the first accident vehicle is associated with the accident of the second accident vehicle.

The method may further comprise: based on a determination that it is necessary to additionally collect accident-related information for the accident of the first accident vehicle and the accident of the second accident vehicle, transmitting, to a nearby vehicle located in the first accident section, a request for image data within a certain time range associated with an accident time at which the accident of the first accident vehicle occurs; and receiving, based on the request for image data, image data acquired by a video recording device of the nearby vehicle.

The method may further comprise determining the accident response instruction by: determining, based on the accident record, an accident severity value indicating severity of the accident of the first accident vehicle; and determining, based on the accident severity value, the accident response instruction.

The determining of the accident severity value may comprise determining the accident severity value based on: a quantity of vehicles involved in at least one of the accident of the first accident vehicle or the accident of the second accident vehicle; a quantity of vehicles in which at least one airbag is deployed; and a quantity of vehicles of which deceleration rates are greater than or equal to a deceleration threshold.

The accident response instruction may comprise: accident section information indicating at least one of the first accident section or the second accident section; and accident image data for the accident; and the transmitting the accident response instruction comprises transmitting, to the at least one vehicle that follows at least one of the first accident vehicle or the second accident vehicle, the accident response instruction based on the accident severity value being greater than or equal to a certain critical value.

The method may further comprise searching for a detour route that bypasses at least one of the first accident section or the second accident section; and transmitting, to the at least one vehicle that follows at least one of the first accident vehicle or the second accident vehicle, the detour route via a communication device, based on the accident severity value being greater than or equal to the certain critical value.

In an aspect, a vehicle operation control server includes: a communication device transmitting and receiving information to and from a vehicle through a network; an accident information collecting processor collecting detailed record data on an accident acquired by an event data recorder of an accident vehicle related to the accident through the communication device; and an accident information processing processor determining accident response measures for a subsequent vehicle that follows the accident vehicle based on the collected accident information.

Through the method of collecting and processing accident information and the vehicle operation control server using the same, a situation at the time of an accident and image data at the time before/after the accident may be remotely collected by a server from a vehicle directly related to a vehicle accident or a vehicle which drives or which has driven in a vehicle accident section to identify the accident situation, thereby being utilized for analysis of a cause of the accident.

In various life/vehicle accident situations caused by vehicles, in many cases, it is not easy to analyze the cause of an accident in various life/vehicle accident situations caused by vehicles due to the fact that the accident vehicle is not equipped with a built-in cam or navigation system and it is difficult to obtain data to determine the accident situation due to damage to related parts. Through the method of collecting and processing accident information and the vehicle operation control server using the same, image data in the vicinity of an accident may be acquired from a vehicle other than the accident vehicle and used to analyze the cause of the accident.

These and other features and advantages are described in greater detail below.

### BRIEF DESCRIPTION OF THE DRAWINGS

FIG. 1 is a diagram showing a configuration of a computing device, such as a server.

FIG. 2 is a flowchart illustrating an operation of a vehicle operation control server.

FIG. 3 is a flowchart illustrating a method of processing accident information of a computing device, such as a server.

### DETAILED DESCRIPTION

Hereinafter, the present disclosure will be described in detail by describing various examples with reference to the accompanying drawings. In describing the present disclosure, if it is determined that a detailed description of a related known configuration or function may obscure the gist of the present disclosure, the detailed description may be omitted. Like reference numerals presented in each figure may indicate like elements.

Terms used in the present application may be used only to describe various examples of the present disclosure, and may not be intended to limit the scope of the present disclosure. A singular form may include a plural form if there is no clearly opposite meaning in the context. It will be further understood that the terms “comprises” or “have” used in this specification, specify the presence of stated features, numerals, components, parts, or a combination thereof, but do not preclude the presence or addition of one or more other features, numerals, components, parts, or a combination thereof.

Throughout the specification, when a portion is “connected” to another portion, it may not only be “directly connected” but also be “electrically or mechanically connected” with other components in between.

If it is not contrarily defined, all terms used herein including technological or scientific terms have the same meanings as those generally understood by a person with ordinary skill in the art. Terms defined in generally used dictionary shall be construed that they have meanings matching those in the context of a related art, and shall not be construed in ideal or excessively formal meanings unless they are clearly defined in the present application.

A program implemented as a set of commands embodying control algorithms necessary for controlling other components may be installed in a component that controls other components under a specific control condition among components described herein. The control component may generate output data by processing input data and stored data according to an installed program. The control component may include a non-volatile memory storing programs and a memory for storing data.

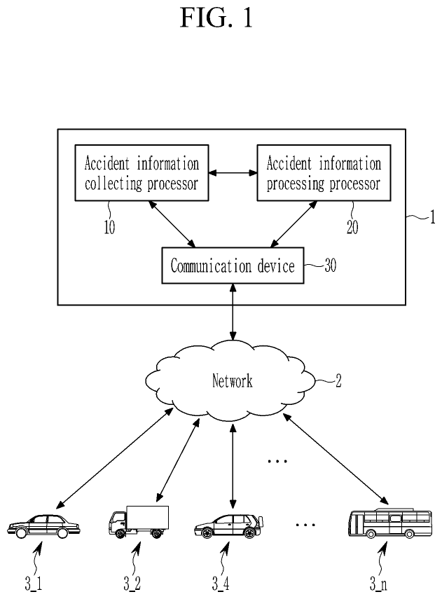

FIG. 1 is a diagram showing a configuration of a computing device, such as a server.

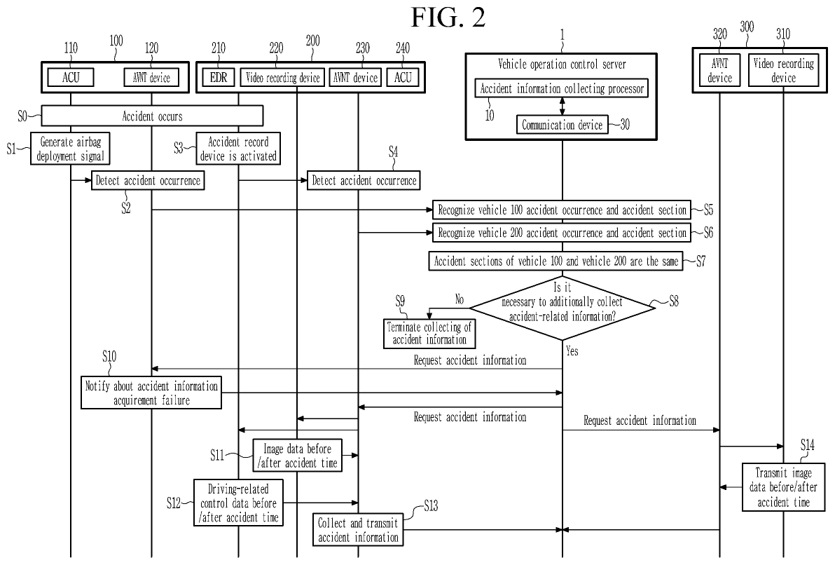

FIG. 2 is a flowchart illustrating an operation of a vehicle operation control server.

As shown in FIG. 1, a computing device (e.g., a vehicle operation control server or any other computing device, such as a cloud system, a network device, etc.) (hereinafter referred to as a “server”) 1 may transmit and receive information to and from a plurality of vehicles 3_1 to 3_n (n is a natural number equal to or greater than 1) which may be driving. The information may be communicated through a wireless network. The plurality of vehicles 3_1 to 3_n may be vehicles capable of performing wireless communication through a network, and may be, for example, vehicles equipped with a telematics function.

The server 1 may include one or more processors and/or controllers (e.g., an accident information collecting processor 10, an accident information processing processor 20, etc.), and a communication device 30. A “processor” refers to a component that processes arithmetic operations, logic operations, determining operations, etc. to provide at least one function, which may be implemented as hardware, software, or a combination of hardware and software. For example, the processor may be implemented by software, such as task, class, subroutine, process, object, execution thread, or program performed in a predetermined region of a memory, or hardware, such as a field-programmable gate array (FPGA) or an application-specific integrated circuit (ASIC), or may be formed of a combination of the above software and hardware. The processor may be included in a computer-readable storage medium, or a part thereof may be distributed in a plurality of computers. In FIG. 1, the accident information collecting processor 10 and the accident information processing processor 20 may be provided as separate processors, but without being limited thereto, the accident information collecting processor 10 and the accident information processing processor 20 may be integrated into one processor.

The communication device 30 may transmit a request or control command received from the accident information collecting processor 10 and the accident information processing processor 20 through a wireless network to a specific vehicle, some vehicles, or a certain vehicle, among the plurality of vehicles 3_1 to 3_n and may receive a response with respect to the request or control command from the specific vehicle, some vehicles, or certain vehicle, among a plurality of vehicles 3_1 to 3_n. The communication device 30 may transmit information received from vehicles to a corresponding processor, among the accident information collecting processor 10 and the accident information processing processor 20.

In FIG. 2, a flowchart of an example method of collecting accident information from a vehicle related to an accident (referred to as an “accident vehicle” hereinafter) and a nearby vehicle located in the same accident section as that of the accident vehicle by an accident information collecting processor 10 of the server 1, according to the occurrence of an accident, is illustrated. The nearby vehicle may refer to a vehicle located in an accident section to which an accident occurrence point belongs or a vehicle located within a predetermined distance from the accident occurrence point. The request or control command transmitted from the accident information collecting processor 10 to each vehicle and the response transmitted from each vehicle to the accident information collecting processor 10 may be transmitted and received by wireless communication between the communication device 30 and a communication device of each vehicle through a network 2. A method of wireless communication is not limited to the specific example described herein, and various other wireless communication methods may be applied to modify the example method.

In FIG. 2, an example in which two vehicles 100 and 200 relate to the same accident is described, but aspects of the present disclosure are not limited thereto. Even when there are three or more accident vehicles, the example illustrated in FIG. 2 may be applied, and the application thereof may be apparent to those skilled in the art.

A vehicle 100 may include an airbag control unit (ACU) 110 and an audio video navigation telematics (AVNT) device 120. Although an example configuration of the vehicle 100 is shown in FIG. 2, aspects of the vehicle 100 are not limited thereto. The vehicle 100 is only an example of a vehicle that does not include a device capable of obtaining information on an accident.

The vehicle 200 may include an event data recorder (EDR) 210, a video recording device 220, and an AVNT device 230. The video recording device 220 may be implemented as a surround view monitoring (SVM) system, which is an imaging system capable of monitoring images around a vehicle, or a built-in cam, which is a built-in driving image record device. The video recording device 220 may include a plurality of cameras capable of capturing images of the front, rear, and side of the vehicle 200. The EDR 210 shown in FIG. 2 may be electrically connected to an airbag control unit (ACU) 240 of the vehicle 200 and may be activated under the control of the airbag control unit. For example, when an airbag is deployed due to an external impact, the airbag controller may activate the EDR 210.

The AVNT device is an example of a device capable of transmitting an image acquired by the video recording device, accident information recorded by an accident recording device, and location information acquired by a GPS device to the outside through a network. In at least some implementations, the AVNT device may be replaced with another component.

The AVNT devices 120 and 230 may acquire vehicle location information (e.g., from the GPS device of the vehicles 100 and 200 or any other devices that retain the vehicle location information), transmit corresponding information in response to a request from the server 1, and transmit various information related to an accident that occurs to the server 1. The AVNT devices 120 and 230 may serve as communication devices of the vehicles 100 and 200.

An accident may occur and the accident may be associated with the vehicle 100 and the vehicle 200 (S0). The airbag of the vehicle 100 may be deployed due to the accident, and the ACU 110 may detect the deployment state of the airbag and generate an airbag deployment indication signal (S1). The ACU 110 may transmit the airbag deployment indication signal to the AVNT device 120, and the AVNT device 120 may detect that an accident has occurred (e.g., based on the airbag deployment indication signal) (S2). The AVNT device 120 may inform the server 1 of the detection of the accident occurrence. For example, the AVNT device 120 may transmit (e.g., to the server 1, vehicles, or any other devices) an accident occurrence signal including information related to the occurrence of the accident. The information related to the occurrence of the accident may include a time at which the accident of the vehicle 100 occurs, location information of an accident occurrence time, and the like. The AVNT device 120 may transmit (e.g., to the server 1, vehicles, or any other devices) the accident occurrence signal including the location information of the vehicle 100 acquired from the GPS device of the vehicle 100 and accident occurrence notification information.

Due to the accident, the EDR 210 of the vehicle 200 may be activated (S3). The EDR 210 may be a device that records data generated by an ACU 240 of the vehicle 200 or an engine electronic control unit (ECU) of the vehicle 200 for a certain period of time. For example, the EDR 210 may record various accident and collision information, such as a speed of the vehicle 200, a brake operation status, an engine rpm, a seat belt wearing status, crash severity (delta_v), an accelerator pedal position, a steering wheel angle, tire pressure, a transmission gear position, airbag development data, etc. and maintain the record for a certain period of time.

The AVNT device 230 may detect the activation state of the EDR 210 and detect the occurrence of the accident (S4). In an example, the AVNT device 230 may detect the occurrence of the accident by detecting the activation state of the EDR 210 and/or an airbag deployment indication signal from the ACU 240. The AVNT device 230 may inform the server 1 (or vehicles, or any other devices) of the detection of the occurrence of the accident. For example, the AVNT device 230 may transmit an accident occurrence signal including information related to the occurrence of the accident to the server 1 (or vehicles, or any other devices). Information related to the occurrence of the accident may include location information of the vehicle 200 (an accident occurrence point). The AVNT device 230 may transmit the accident occurrence signal including the location information of the vehicle 200 (e.g., acquired from the GPS device of the vehicle 200) and the accident occurrence notification information to the server 1 (or vehicles, or any other devices).

The accident information collecting processor 10 may receive the accident occurrence signal from the vehicle 100, recognize the occurrence of the accident of the vehicle 100, and determine an accident section based on the location information of the vehicle 100 (S5). The accident information collecting processor 10 may be implemented in the server 1 (or vehicles, or any other devices). The accident information collecting processor 10 may receive the accident occurrence signal from the vehicle 200, recognize the accident occurrence of the vehicle 200, and determine the accident section based on the location information of the vehicle 200 (S6). The accident information collecting processor 10 may store link data for roads and derive link data corresponding to the location of the accident vehicle based on the vehicle location information. Each of the roads may be divided into certain units (or sections, segments, etc.) and identification data may be assigned to each unit (or section, segment, etc.). The certain unit refers to a unit set to identify a certain section of a road, such as a section between intersections, and may be referred to as a “link”. The accident information collecting processor 10 may classify each of the entire roads located in the entire region providing a vehicle operation control service into links, and assign an identification ID corresponding to each link. The identification ID assigned to each link is referred to as link data. The server 1 may receive the accident occurrence signal from each of the vehicles 100 and 200, and derive link data corresponding to the location in which each accident occurs based on GPS information included in the accident occurrence signal to determine an accident section.

Since the accident information collecting processor 10 may need information on the accident of the vehicle 100, the accident information collecting processor 10 may perform a search process for a certain search period to determine whether there is a vehicle related to the accident of the vehicle 100. For example, the accident information collecting processor 10 may search for a vehicle involved in an accident that has occurred within a certain search period based on the accident occurrence time of the vehicle 100. The search period may be set to include a certain period before and after the accident occurrence time of the vehicle 100. For at least some implementations, it is assumed that an accident of the vehicle 200 occurs within a search period based on the accident occurrence time of the accident of the vehicle 100.

The accident information collecting processor 10 may determine whether the accident section of the vehicle 200 is the same as the accident section of the vehicle 100 (S7). For example, the accident information collecting processor 10 may compare the link data corresponding to the accident occurrence location of the vehicle 100 with the link data corresponding to the accident occurrence location of the vehicle 200 to determine whether the accident sections are the same.

The accident information collecting processor 10 may determine whether additional accident-related information needs to be collected (S8). Upon receiving the accident occurrence signal, if accident information cannot be acquired from the vehicle that has transmitted the accident occurrence signal or if more information is required to accurately identify the accident, the accident information collecting processor 10 may determine that accident-related information needs to be additionally collected. Accurately identifying accident information (e.g., an accident circumstance), for example, determining specific circumstances of the accident and the degree of damage, such as whether the accident is an accident involving a single vehicle or a collision between two or more vehicles, whether there are additional vehicles involved in the same accident, the degree of damage caused by a collision between vehicles, and loss of lives, and the like. In at least some implementations, step S8 may not be performed, and the accident information collecting processor 10 may perform a step for additionally collecting accident-related information without performing step S8. As a result of the determination in step S8, when there is no need to additionally collect accident-related information, the accident information collecting processor 10 may terminate a process of collecting accident information (S9).

However, since the information acquired in steps S5 and S6 is only information on the accident section, the accident information collecting processor 10 may determine that additional information related to the accident is required in step S8. In a case in which the accident information collecting processor 10 notifies other vehicles of only the occurrence of the accident and the accident section, additional information on the accident may not be necessary. In at least some implementations, since the server 1 may operate differently according to the degree of the accident (e.g., the accident severity), it may be determined that additional information on the accident is necessary.

As a result of the determination in step S8, if additional accident-related information needs to be collected, the server 1 (or vehicles, any other devices, etc.) may request accident information for the vehicle 100 and the vehicle 200. The request may be sent to one or more vehicles. The requested accident information may include detailed record data on the accident acquired through the EDR installed in the vehicle, image data of the built-in cam installed in the vehicle, and the like.

As described above, since the vehicle 100 does not have a device capable of collecting accident-related information other than the ACU 110, the AVNT device 120 may inform the server 1 about an accident information acquisition failure indicating that the accident information cannot be acquired (S10).

The server 1 may transmit an accident information request to the vehicle 200. The AVNT device 230 of the vehicle 200 may receive an accident information request from the server 1, request image data within a certain time range before/after an accident occurrence time from the video recording device 220 based on the accident occurrence time, and request driving-related control data within the certain time range before/after the accident occurrence time from the EDR 210 based on the accident occurrence time.

In response to the above request, the video recording device 220 may transmit image data within the certain time range before/after the accident occurrence time to the AVNT device 230 based on the accident occurrence time (S11), and the EDR 210 may transmit the driving-related control data within the certain time range before/after the accident occurrence time to the AVNT device 230 based on the accident occurrence time (S12).

The AVNT device 230 may collect the accident information received from the video recording device 220 and the EDR 210 and transmit the collected information to the server 1 (or vehicles, any other devices, etc.) (S13).

If the accident information collecting processor 10 determines that it is necessary to additionally collect accident-related information in step S10, the accident information collecting processor 10 may request accident information from a nearby vehicle 300 which has driven near the vehicle 100 and/or the vehicle 200 in the accident occurrence section, as well as the vehicle which has transmitted the accident occurrence signal. In FIG. 2, the vehicle 300 may be one of accident nearby vehicles. Although only one nearby vehicle 300 is shown in FIG. 2, there may be two or more nearby vehicles.

A method of the accident information collecting processor 10 selecting the vehicle 300 may be implemented in various manners. For example, a vehicle which has recorded EDR data including data similar to the EDR data provided from the vehicle 200 of the accident occurred within a certain period before and after the accident occurrence time in the accident section may be searched for by the server 1. The EDR data may include data, such as vehicle operation data indicating a sudden stop of the vehicle. If the vehicle 200 of the accident cannot provide EDR data, a vehicle recording EDR data including specific data highly related to the accident, such as a sudden stop, within the certain period before and after the accident occurrence time in the accident section may be searched for by the server 1.

If the accident information collecting processor 10 determines that additional accident-related information needs to be collected in step S10, the server 1 (or vehicles, any other devices, etc.) may transmit an accident information request to the vehicle 300. The AVNT device 320 of the vehicle 300 may receive an accident information request from the server 1 (or vehicles, any other devices, etc.) and request image data within a certain time range before/after the accident occurrence time from the video recording device 310 based on the accident occurrence time.

In response to the above request, the video recording device 310 may transmit image data within the certain time range before/after the accident time based on the accident time to the AVNT device 320 (S14), and the AVNT device 230 may transmit the received image data to the server 1 (or vehicles, any other devices, etc.).

The accident information processing processor 20 may receive accident information collected from the accident information collecting processor 10 and determine accident response measures for one or more other vehicles (e.g., one or more vehicles that follow the vehicle involved in the accident) according to the accident information. For example, the accident information processing processor 20 may determine an accident severity value of the accident based on the accident information, determine accident response measures for the subsequent vehicle according to the accident severity value, and transmit the determined measures to the one or more other vehicles. The one or more other vehicles may include one or more subsequent vehicles, which may be referred to as a vehicle that follows the accident vehicle by a predetermined distance or longer on a driving route based on a point at which the accident occurs.

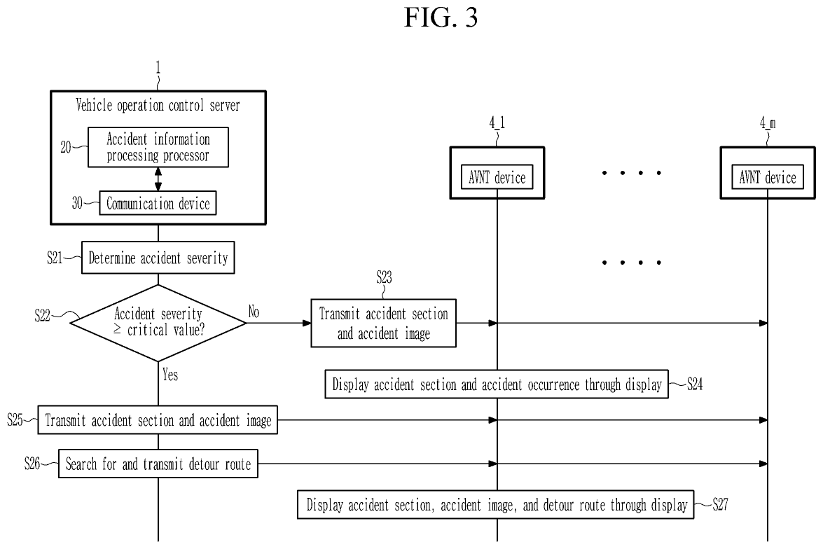

FIG. 3 is a flowchart illustrating a method of processing accident information of a computing device, such as a server.

In FIG. 3, a plurality of subsequent vehicles 4_1 to 4_m (m is a natural number of 1 or greater) are shown, and each of the plurality of subsequent vehicles may include an AVNT device.

The accident information processing processor 20 may determine accident severity based on accident information (e.g., received from the accident information collecting processor 10) (S21). The accident severity may be a value quantifying a scale of the accident and the degree of damage caused by the accident. As the accident severity increases, the scale and damage of the accident may increase. Information necessary for the accident information processing processor 20 to determine the severity may include the number of vehicles involved in the same accident, the number of airbag deployed vehicles among the accident vehicles, and the number of vehicles that suddenly stop among the accident vehicles.

The accident information processing processor 20 may determine the number of vehicles involved in the same accident by analyzing image data acquired from the accident vehicle and nearby vehicles among vehicles having the same link data in the accident section. As explained above, the accident information processing processor 20 may determine that vehicles having an accident occurrence time that falls within a certain reference time and the same accident section, as vehicles related to the same accident.

The accident information processing processor 20 may determine whether the airbag was deployed using an airbag deployment indication signal generated by the ACU of each vehicle. The accident information processing processor 20 may use information on whether an operation of a vehicle body posture control device has been triggered before a sudden stop acquired through the EDR in order to determine whether to determine a sudden stop.

The accident information processing processor 20 may determine whether the number of the accident vehicles is more than one. In the case of a single accident vehicle, the accident information processing processor 20 may determine the severity according to whether the airbag of the vehicle was developed. For example, if there is only one accident vehicle and the airbag was not deployed, the accident information processing processor 20 may determine the accident severity as 1, which may be the lowest. If there is only one accident vehicle and the airbag is deployed, the accident information processing processor 20 may determine the accident severity as 2.

If there are a plurality of accident vehicles, the accident information processing processor 20 may determine the accident severity according to the number of vehicles in which airbags are deployed among the plurality of vehicles. For example, if there are two vehicles in an accident and all airbags are not deployed, the accident information processing processor 20 may determine the accident severity as 2. If there are two vehicles in an accident and the airbag in one of the two vehicles is deployed, the accident information processing processor 20 may determine the accident severity as 3. If there are two vehicles in an accident and airbags are deployed in both vehicles, the accident information processing processor 20 may determine the accident severity as 4.

The accident information processing processor 20 may increase the accident severity by a certain unit (e.g., by one) according to the number of vehicles that suddenly stopped among the accident vehicles. For example, if there are two vehicles in an accident, airbags are deployed in both vehicles, and one vehicle suddenly stopped, the accident information processing processor 20 may determine the accident severity as 5.

The accident information processing processor 20 may compare the accident severity with a certain critical value (e.g., a threshold value) that is a criterion for determining seriousness of the accident (S22).

For example, the accident information processing processor 20 may determine whether the accident severity is greater than or equal to the critical value. As a result of the determination in step S22, if the accident severity is less than the critical value, the accident information processing processor 20 may notify the subsequent vehicles 4_1 to 4_m of the accident section and the occurrence of the accident (S23). For example, the accident information processing processor 20 may transfer an accident occurrence notification along with information (accident section information) indicating the accident section to the communication device 30, and the communication device 30 may transmit the accident occurrence notification to the subsequent vehicles 4_1 to 4_m through the network 2 (S23). The subsequent vehicles 4_1 to 4_m may display the accident section and accident occurrence on a display provided in the vehicle (S24).

As a result of determination in step S22, if the accident severity is greater than or equal to the critical value, the accident information processing processor 20 may transmit the accident section and an accident image to the subsequent vehicles 4_1 to 4_m (S25). For example, the accident information processing processor 20 may transfer accident image data acquired through the video recording device of the accident vehicle and the nearby vehicle, together with the information (the accident section information) indicating the accident section, to the communication device 30. The communication device 30 may transmit the same to the subsequent vehicles 4_1 to 4_m through the network 2. The accident information processing processor 20 may search for a detour path for bypassing the accident section and transmit searched at least one detour path to the subsequent vehicles 4_1 to 4_m (S26).

The subsequent vehicles 4_1 to 4_m may display the accident section, the accident image, and/or the detour route on the display provided in the vehicle (S27).

As such, the server, the vehicles, road side units, computing devices, etc.) may recognize the occurrence of an accident, acquire accident information from the accident vehicle as well as nearby vehicles, and transmit the accident information to a subsequent vehicle.

Example operations of the server have been described in detail, but this is only for describing example aspects of the present disclosure, and the scope of the present disclosure is not limited thereto. Those of ordinary skill in the art will understand that various modifications and equivalent implementations are possible from the present disclosure.

What is claimed is:

1. An apparatus comprising:
a communication device configured to communicate with at least one vehicle; and
at least one processor configured to:
receive, from the at least one vehicle, record data of an accident, wherein the record data is acquired by an event data recorder of the at least one vehicle related to the accident; and
determine, based on the record data, an accident response instruction for a vehicle that follows an accident vehicle.

2. The apparatus of claim 1, wherein:
the at least one vehicle comprises the accident vehicle; and
the at least one processor is configured to:
receive location information of the accident vehicle, and
determine, based on the location information of the accident vehicle, an accident location in which the accident occurs.

3. The apparatus of claim 1, wherein:
the at least one processor is configured to:
transmit, to the at least one vehicle, a request for accident information via the communication device, and
receive, based on the request for accident information, the record data of the accident vehicle in response to the request.

4. The apparatus of claim 1, wherein:
the at least one processor is configured to:
transmit, to the at least one vehicle, a request for accident information via the communication device, and
receive, based on the request for accident information, image data associated with at least one image of the accident acquired by a video recording device of the at least one vehicle.

5. The apparatus of claim 4, wherein:
based on a determination that accident-related information on the accident needs to be additionally collected through the communication device,
the at least one processor is configured to transmit a request for the record data and the image data to the accident vehicle.

6. The apparatus of claim 2, wherein:
based on a determination that accident-related information on the accident needs to be additionally collected through the communication device,
the at least one processor is configured to transmit, to the at least one vehicle, a request for image data within a certain time range associated with an accident time at which the accident occurs, wherein the at least one vehicle comprises a nearby vehicle located in the accident location, and receive, based on the request for image data, image data acquired by a video recording device of the nearby vehicle.

7. The apparatus of claim 6, wherein:
the nearby vehicle is a vehicle that transmits event data recorder (EDR) data including data associated with EDR data provided from the accident vehicle within the certain time range.

8. The apparatus of claim 6, wherein:
the nearby vehicle is a vehicle that transmits event data recorder (EDR) data including specific data associated with the accident within the certain time range.

9. The apparatus of claim 1, wherein:
the at least one processor is configured to:
determine, based on the record data, an accident severity value indicating severity of the accident,
determine, based on the determined accident severity value, the accident response instruction, and
transmit the accident response instruction via the communication device.

10. The apparatus of claim 9, wherein:
the at least one processor is configured to:
determine the accident severity value based on:
a quantity of accident vehicles involved in the accident,
a quantity of accident vehicles in which at least one airbag is deployed, and
a quantity of vehicles of which deceleration rates are greater than or equal to a deceleration threshold.

11. The apparatus of claim 9, wherein:
based on the accident severity value being greater than or equal to a certain critical value,
the at least one processor is configured to:
transmit, to the vehicle that follows the accident vehicle, accident section information indicating an accident location and accident image data for the accident via the communication device.

12. The apparatus of claim 11, wherein:
based on the accident severity value being greater than or equal to the certain critical value,
the at least one processor is configured to:
search for a detour route that bypasses the accident location, and
transmit, to the vehicle that follows the accident vehicle, the detour route via the communication device.

13. The apparatus of claim 9, wherein:
based on the accident severity value being less than a certain critical value,
the at least one processor transmits accident section information indicating an accident location and an accident occurrence notification, to the vehicle that follows the accident vehicle, via the communication device.

14. The apparatus of claim 1, wherein:
the communication device receives a portion of the record data from an audio video navigation telematics (AVNT) device of the accident vehicle.

15. A method performed by a computing device, the method comprising:
receiving an accident occurrence signal from a first accident vehicle;
determining a first accident section in which an accident of the first accident vehicle occurs;
receiving an accident occurrence signal from a second accident vehicle;
determining a second accident section in which an accident of the second accident vehicle occurs;
transmitting, to the first accident vehicle and the second accident vehicle, a request for accident information;
receiving accident record acquired by an accident recording device of at least one of the first accident vehicle or the second accident vehicle; and
transmitting, based on the accident record, an accident response instruction for at least one vehicle that follows at least one of the first accident vehicle or the second accident vehicle.

16. The method of claim 15, further comprising:
receiving, based on the request for accident information, accident image data acquired by a video recording device of at least one of the first accident vehicle or the second accident vehicle.

17. The method of claim 15, further comprising:
based on the first accident section and the second accident section being the same and based on an accident time at which the accident of the first accident vehicle occurs and an accident time at which the accident of the second accident vehicle occurs being within a certain time period, determining that the accident of the first accident vehicle is associated with the accident of the second accident vehicle.

18. The method of claim 17, further comprising:
based on a determination that it is necessary to additionally collect accident-related information for the accident of the first accident vehicle and the accident of the second accident vehicle, transmitting, to a nearby vehicle located in the first accident section, a request for image data within a certain time range associated with an accident time at which the accident of the first accident vehicle occurs; and
receiving, based on the request for image data, image data acquired by a video recording device of the nearby vehicle.

19. The method of claim 15, further comprising:
determining the accident response instruction by:
determining, based on the accident record, an accident severity value indicating severity of the accident of the first accident vehicle; and
determining, based on the accident severity value, the accident response instruction.

20. The method of claim 19, wherein the determining of the accident severity value comprises determining the accident severity value based on:
a quantity of vehicles involved in at least one of the accident of the first accident vehicle or the accident of the second accident vehicle;
a quantity of vehicles in which at least one airbag is deployed; and
a quantity of vehicles of which deceleration rates are greater than or equal to a deceleration threshold.

21. The method of claim 19, wherein:
the accident response instruction comprises:
accident section information indicating at least one of the first accident section or the second accident section; and
accident image data for the accident; and
the transmitting the accident response instruction comprises transmitting, to the at least one vehicle that follows at least one of the first accident vehicle or the second accident vehicle, the accident response instruction based on the accident severity value being greater than or equal to a certain critical value.

22. The method of claim 21, further comprising:
searching for a detour route that bypasses at least one of the first accident section or the second accident section; and
transmitting, to the at least one vehicle that follows at least one of the first accident vehicle or the second accident vehicle, the detour route via a communication device, based on the accident severity value being greater than or equal to the certain critical value.
